(19) United States
(12) Patent Application Publication
(10) Pub. No.: US 2020/0392279 A1
(43) Pub. Date: Dec. 17, 2020

(54) POLYOL COMPOSITIONS FOR FOAM INSULATION

(71) Applicant: INVISTA TEXTILES (U.K.) LIMITED, Manchester (GB)

(72) Inventor: Carina Araullo MCADAMS, Wilmington, NC (US)

(73) Assignee: INVISTA NORTH AMERICA S.A.R.L., WILMINGTON, DE (US)

(21) Appl. No.: 16/494,318

(22) PCT Filed: Mar. 22, 2018
(86) PCT No.: PCT/US18/23732

§ 371 Date: Sep. 16, 2019

Related U.S. Application Data
(60) Provisional application No. 62/475,988, filed on Mar. 24, 2017.

(51) Int. Cl. C08G 18/42; C08G 18/72; C08G 18/32; C08G 18/22; C08G 18/18

(52) U.S. Cl. CPC C08G 18/4208; C08G 18/72; C08G 2101/005; C08G 18/225; C08G 18/1808; C08G 18/3215

(57) ABSTRACT

The present invention relates to emulsion compositions of modified polyester polyols and a method of preparing such modified polyester polyol emulsions that are useful in the formulation of polyurethane and polyisocyanurate cellular polymers for use in making foam articles.

This application claims priority to PCT Application No. PCT/US2018/23732, filed on Mar. 22, 2018, which further claims priority to U.S. Provisional Application No. 62/475,988 filed Mar. 24, 2017, which are incorporated herein by reference in their entirety.

### FIELD

The present invention relates to emulsion compositions of modified polyester polyols and a method of preparing such modified polyester polyol emulsions. The emulsion compositions are useful in the formulation of polyurethane and polyisocyanurate cellular polymers for use in making foam articles.

### BACKGROUND

Polyurethane (PUR) and polyisocyanurate (PIR) cellular foams have been among the most widely used and versatile insulating materials in many applications. These find use in applications such as, for example, insulation of cooling and heating appliances, pour-in-place door panels, construction insulation, lamination of insulation panels, spray foam insulation, structural foams for housing, wood lamination, packaging, etc.

Aromatic polyester polyols (herein referred to as APPs) have been in the PUR/PIR industry for the past four decades and play a role in various PUR/PIR rigid foam applications, including PUR spray foam systems. Industrial uses of APPs include manufacture of PUR and/or PIR polymer products. The PUR and PIR polymers are polyfunctional and can be used as adhesives, binders (e.g., for wood fibers), coatings, and foams. The known benefits include low-cost, rigid cellular structure and excellent properties that are desired for many end-use applications.

In the rigid foam insulation industry that uses PIR/PUR foams, manufacture of rigid foams with fine cellular structure is desirable to give improved insulation properties (i.e., improved R-value). In reacting the A-side component (organic isocyanates) with the B-side component (polyol emulsion) in the presence of a blowing agent (for instance AB mixture with a good balance of foaming versus unique cellular structures with well-formed cell boundaries is required. Proper choice of surfactant during the reactive AB step is needed to develop acceptable cell structure and reduced defects. The problems still exist in this step with elongated cells, collapsed cellular structures as such, which adversely affect the structural, mechanical strength and insulation properties of the final foam structure, especially in systems using hydrocarbon blowing agents.

Specifically, the use of hydrocarbons including C₅ hydrocarbons will include n-pentane, iso-pentane, cyclopentane, and blends thereof. During the foam blowing process involving isocyanates (A-side component) and polyols emulsion (B-side component), C₅ hydrocarbons as blowing agents must sufficiently homogenize and compatibilize in the reactive AB-emulsion matrix. This is important in order to uniformly disperse the blowing agent such that a stable, well-formed cellular substance with round cell structures can be formed. Such fine well rounded cellular structures will have desirable foam properties such as dimensional stability, mechanical strength, processing ease and insulation performance.

GB842271A relates to a polyurethane foam containing from 0.5% to 10% by weight of an antioxidant which is a polyhydric phenol for improving the stability of the foam over time.

U.S. Pat. No. 3,772,218A relates to foam-forming compositions containing various antioxidants including substituted hydroquinones.

U.S. Pat. No. 4,360,682A relates to caprolactones stabilized with dihydroxy benzene compounds, where the caprolactones are to be used for polycaprolactone-polyols, and such polyols are to be used as a starting material in the preparation of polyurethanes.

EP1023377B1 relates to polyols with thermo-oxidative stability having a stabilizer of one type and a costabilizer of hindered phenol structure, including compounds such as 4,4′-dihydroxydiphenol.

WO2011031598A1 relates to a method of producing a uniformly distributed polyurethane foam with hydroquinone among possible stabilizers.

WO2011137033A1 relates to a method of thermosetting foam blends by including stabilizers/inhibitors (including hydroquinone) in the premix.

US20150197614A1 relates to polyurethane polyol blends containing a halogenated blowing agent, with benzene diol and triol antioxidants.

### SUMMARY

The disclosed compositions provide polyols (B-side component) with good interaction and compatibility with blowing agents enriched in hydrocarbons in the PIR/PUR manufacturing process. PIR/PUR foams (as well as precursors for making such foams) are disclosed providing more uniformly shaped and evenly sized cellular spaces, thus improving insulation efficiency (measured as “R” value).

An embodiment of the invention is a foam precursor comprising:
a) polyol;
b) R-value enhancing additive comprising at least one selected from aryl diols and aryl triols and combinations thereof; and
c) surfactant, wherein the HLB number of the surfactant is from 5 to 20 on Griffin's scale.

The polyol can be a polyester polyol, for example, an aromatic polyester polyol.

The R-value enhancing additives elected from aryl diols and aryl triols can comprise at least one selected from substituted aryl diols, substituted aryl triols, unsubstituted aryl diols, unsubstituted aryl triols and combinations thereof.

The R-value enhancing additives elected from aryl diols and aryl triols can comprise resorcinol, for example a majority of resorcinol, for example from 80 wt % to 100 wt %, such as from 90 to 100 wt %, of the R-value enhancing additive.

Another embodiment of the invention is an emulsion comprising the reaction product of the foam precursor composition, wherein the emulsion is a homogeneous mixture with viscosity in the range of 500 to 10,000 centipoise, determined at 25° C. according to ASTM D-4878.

A foam composition of the invention can be produced from the foam precursor by reacting the foam precursor with organic isocyanates at conditions sufficient to develop a reaction product having the weight per unit volume of at least 1.4 lb/ft³, for example from 1.4 to 1.6 lb/ft³, such as 1.5 lb/ft³, and insulation R-value of greater than 6, for example from greater than 6 to 40, such as from 6.1 to 35.

The disclosed foam-forming reaction can suitably be carried out in using a blowing agent, for example, a predominately non-halogenated hydrocarbon blowing agent. For example, the blowing agent can contain less than 1 wt %, for example from 0.1 to less than 1 wt %, fully halogenated alkanes.

The surfactant for the disclosed foam precursor can have an HLB number of from 10 to 20 on Griffin's scale.

Another embodiment of the invention is a foam comprising:
a) an aromatic polyester polyol;
b) R-value enhancing additive comprising at least one selected from aryl diols and aryl triols, and combinations thereof, for example, resorcinol, for example from ≥80 wt. % resorcinol to ≤100 wt. % resorcinol;
c) surfactant, wherein the HLB number of the surfactant is from 5 to 20 on Griffin's scale;
d) an isocyanate; and
e) a blowing agent, for example, a blowing agent containing less than 1 wt. %, for example from 0.1 to less than 1 wt. %, of fully halogenated alkanes.

The foam of the invention is suitably produced from an emulsion composition comprising a homogeneous mixture which comprises polyol, R-value enhancing additive and surfactant, with viscosity in the range of 500 to 10,000 centipoise, determined at 25° C. according to ASTM D-4878, wherein the emulsion composition is reacted with organic isocyanates at conditions sufficient to develop a cellular matrix substance having the weight per unit volume of at least 1.4 lb/ft³, for example from 1.4 to 1.6 lb/ft³, such as 1.5 lb/ft³, and insulation R-value of greater than 6, for example from greater than 6 to 40, such as from 6.1 to 35.

The foam of the invention can exhibit improved properties including more nearly spherical and more uniformly sized and distributed cell structure than the same composition formed in the absence of aryl diol or aryl triol R-value enhancing additive, for example, resorcinol.

The foam of the invention can include those in which the HLB number of the surfactant is from 10 to 20 on Griffin's scale.

The foam of the invention can include closed-cell foams, such as the reaction product of polyester polyol, isocyanate, R-value enhancing additive and surfactant formed in the presence of blowing agent, wherein:
a) the R-value enhancing additive comprises a compound selected from aryl diols, substituted aryl diols, aryl triols, substituted aryl triols and combinations thereof; and
b) the concentration of the surfactant on the surfaces of the closed cells is greater than the concentration of the surfactant in the bulk of the cell walls.

For the closed-cell foam of the invention, the HLB number of the surfactant can be from 5 to 20 on Griffin's scale, for example, from 10 to 20.

### BRIEF DESCRIPTION OF THE FIGURES

FIGS. 1 and 2 illustrate the results of Example 1.

FIG. 3 illustrates the results of Example 2.

FIG. 4 illustrates the results of Example 3.

FIG. 5 illustrates the results of Example 4.

FIG. 6 illustrates the results of Example 6.

### DETAILED DESCRIPTION

It is to be understood that this invention is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the suitable methods and materials are now described.

All percent compositions are given as weight percentages or wt. %, unless otherwise stated. When solutions or mixtures of components are referred to, percentages refer to weight percentages of the component relative to the total composition unless otherwise indicated.

All average molecular weights of polymers are weight-average molecular weights, unless otherwise specified.

Pressures reported as pounds per square inch gauge (Psig) are relative to one atmosphere. One pound per square inch equals 6.895 kilopascals (kPa). One atmosphere is equivalent to 101.325 kPa or about 14.7 pounds per square inch absolute (Psia) or about zero Psig.

The term “foam” is used to refer to a cellular structure produced by an expansion process, known as “foaming”, and also, having a comparatively low weight per unit volume (or density) and with low thermal conductivity. The cellular structure is made up of well-defined cell boundaries, wherein a low density component (such as gas) is dispersed and confined within the cells distributed across a continuous phase (liquid or solid). Cellular foams can be light-weight or heavy, porous or dense, semi-rigid or rigid, or flexible spongy materials depending on the end-use application. Rigid foams are usually the solidified form of a continuous liquid matrix full of gas-filled cells or bubbles dispersed within the matrix. Rigid foams are often used as insulators for noise abatement, shock absorption and/or as heat insulators in construction, in cooling and heating technology (e.g., household appliances), for producing composite materials (e.g., sandwich elements for roofing and siding), and for wood simulation material, model-making material, and packaging.

Disclosed is a method of incorporating an additive into a foam-forming mixture by separately reacting the additive with a polyester polyol (the “B” side of a later AB reaction”) to provide beneficial effects in a product formed later (by reaction with the “A” side, for example, an isocyanate) in a reactive AB step. The process improvement comes from the increased polyester polyol emulsion in the presence of blowing agent as a foam precursor and a further reacting the foam precursor with the A-side or isocyanate component, thereby maintaining a right balance of foaming/cellular structure build in the final foam product. It may be possible to either minimize or even eliminate the surfactant that is otherwise introduced during the reactive AB step, further simplifying the process.

The emulsion compositions prepared by the disclosed method can further include one or more other components known to those skilled in the art and dependent on end use. Such components may include other polyols, solvents, catalysts, chain extenders, cross-linkers, curing agents, surfactants, blowing agents, fillers, flame retardants, plasticizers, light stabilizers, colorants, waxes, biocides, minerals, micronutrients, inhibitors, stabilizers or other organic or inorganic additives.

The emulsion compositions prepared by the disclosed method can be used in formation of a resin blend, suitable as a “B-side component” of a pre-polymer composition. The resin blend may comprise the modified polyester polyol emulsion of the present disclosure and may further include other polyols, solvents, catalysts, chain extenders, cross-linkers, curing agents, surfactants, blowing agents, fillers, flame retardants, plasticizers, light stabilizers, colorants, waxes, biocides, minerals, micronutrients, inhibitors, stabilizers or other organic or inorganic additives.

The disclosed resin blend can be reacted with a polyfunctional isocyanate (“A-side component”), such as methylene diphenyl diisocyanate (MDI) or a polymeric MDI (PMDI), to provide a pre-polymer composition of the present disclosure. Reaction of the A-side and B-side components may provide new PUR and/or PIR polymers depending upon the specific conditions implemented.

Non-limiting examples of the A-side component can be Mondur® MR Lite from Bayer Corporation and Rubinate® M from Huntsman Corporation. However, it is not intended the A-side component be limited to those specifically illustrated herein. For example, the A-side component of the formulations of the present disclosure can be selected from organic polyisocyanates, modified polyisocyanates, isocyanate-based prepolymers, and mixtures thereof. Such choices can also include aliphatic and cycloaliphatic isocyanates, but aromatic and especially multifunctional aromatic isocyanates are particularly useful.

The B-side component can be a resin blend containing one or more Mannich polyols, one or more polyester polyols, and one or more polyether polyols (as well as polyols of the present disclosure). Additionally, the B-side component can contain catalysts, surfactants, flame retardants, and/or blowing agents. An example of Mannich polyol is Jeffol® R-425X available from Huntsman Corp. Non-limiting examples of aromatic polyester polyols are Terate®HT 5500, Terate® HT 5510, Terate®HT 2000, etc. polyols, that are commercially available from INVISTA S.á r. 1. An example of polyether polyol is Voranol™ 360 from Dow Corp.

The PUR/PIR foam can be produced at various volume ratios of resin blend composition and polyisocyanate to obtain a certain Isocyanate Index. The ratios are normally referred to as A:B where “A” (or A-side component) is the polyisocyanate and “B” (or B-side component) is the resin blend. In an embodiment, the ratio can be, for example, from 1:1 to 3:1.

The use of PUR and/or PIR polymers of the present disclosure may include various amines and polyamines as chain extenders, cross-linkers, curing agentsin coatings application. In other embodiments, the PUR and/or PIR polymers of the present disclosure may be used for fiber-reinforced compositions, such as a wood fiber reinforced composite. In some other embodiments, the use of PUR and/or PIR polymers of the present disclosure may provide a foam composition, comprising a pre-polymer composition according to the present disclosure with a suitable blowing agent. The foam composition can be spray foam.

The isocyanate can include any isocyanate with an average functionality of at least 2 that can be used to make a suitable polyurethane (PUR) and/or polyisocyanurate (PIR) foam.

Polyurethane (PUR) and/or polyisocyanurate (PIR) polymers are useful in accordance with the disclosed process. The PUR and/or PIR polymer can include a polyester polyol composition and a resin blend composition containing a polyester polyol composition according to the present disclosure, a catalyst, a surfactant, and a blowing agent. The polyester polyol composition can include any of the polyol compositions described herein. In addition, the catalyst, the surfactant, and the blowing agent can be any of the catalyst, the surfactant, and the blowing agent described herein. In an embodiment the polyol composition can be present in an amount so that the foam produced from the PUR and/or PIR polymer has a bio-based content of up to 20% by weight of the total organic carbon in the foam, or up to 15% by weight of the total organic carbon in the foam.

### R-Value Enhancing Additives

Suitable R-value enhancing additives can be selected from aryl diols and aryl triols, substituted aryl diols and triols, or unsubstituted aryl diols and triols. Aryl diols can comprise resorcinol, for example a majority of resorcinol, for example from 90 wt % to 100 wt % of the R-value enhancing additive. Other R-value enhancing additives can also be used, for example isomers of aryl diols, aryl triols, and mixture thereof.

Non-limiting examples of suitable R-value enhancing additives may include ADEKA polymer additives, such as, ADK STAB series phosphites and phenolics that are commercially used in engineering polymers, plastics, polyolefins, ABS, PVC, polystyrenes, polyurethanes, rubbers, etc.Refer to Adeka internet website for details on examples of such additives—http://www.adeka.co.jp/en/chemical/products.

In one aspect of this invention, a chemical class of di-hydroxybenzenes (or aryl diols), tri-hydroxybenzenes (or aryl triols), their analogs and derivatives may be used as R-value enhancing additives.

Examples of di-hydroxybenzene (also known as benzenediol; C₆H₆O₂) are its three ortho-meta-para isomers, namely, 1,2-benzenediol (Catechol; CAS No. 120-80-9), 1,3-benzenediol (Resorcinol; CAS No. 108-46-3), and 1,4-benzenediol (Hydroquinone; CAS No. 123-31-9). The chemical structures for three di-hydroxybenzene isomers are below.

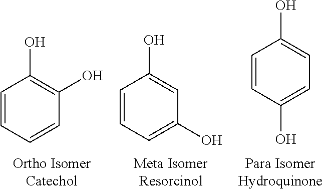

In some embodiments, catechol may be used as an R-value enhancing additive in polyol-derived foam preparations. In other embodiments, resorcinol may be used as an R-value enhancing additive in polyol-derived foam preparations. In some other embodiments, hydroquinone may be used as an R-value enhancing additive in polyol-derived foam preparations. Resorcinol is a preferred additive in the examples of this disclosure.

Examples of tri-hydroxybenzene (also known as benzenetriol; C₆H₆O₃) are its three isomers, namely, benzene-1,2,4-triol (Hydroxyquinol; CAS No. 533-73-3), benzene-1,3,5-triol (Phloroglucinol; CAS No. 108-76-3), and benzene-1,2,3-triol (Pyrogallol; CAS No. 87-66-1). The chemical structures for three tri-hydroxybenzene isomers are below.

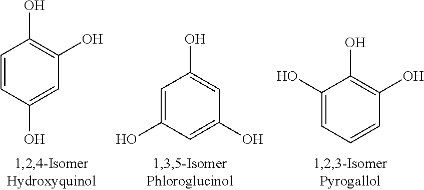 [SMILES: Oc1ccc(O)c(O)c1 ; Oc1cc(O)cc(O)c1 ; Oc1cccc(O)c1O]

The benzene diols and triols may be substituted (i.e., the aromatic ring may be substituted with one or more groups other than hydrogen and hydroxyl) or unsubstituted (i.e., the aromatic ring does not bear any substituents other than hydrogen and hydroxyl). Substitutions may include, for example, alkyl groups (both straight chain and branched as well as cycloalkyl), such as methyl, ethyl, propyl, and butyl (e.g., n-butyl, sec-butyl, tert-butyl) groups, as well as other types of substituents such as aryl, aryloxy, substituted carbonyl, alkaryl, halogen, alkoxy, or cyano groups or the like.

The process, emulsions and foams include the use of an aromatic polyester polyol composition in a polyol emulsion composition for PUR/PIR polymer. Embodiments of this invention relate to the manufacturing of PUR/PIR derived foams hydrocarbon based blowing agents as described above with or without water at a high index. The foam formed has suitable physical and insulation characteristics (e.g., having an R-value of greater than 6 and parallel compressive strength greater than 20 psig at a weight per unit volume, or density, of less than 1.6 lb/ft³) as well as having low surface friability according to the friability test method described elsewhere herein.

The emulsion compositions of the present disclosure may be prepared by methods known to the skilled person. For example, compositions containing the resin blend can be added to a blend tank and mixed under ambient conditions and, if the blend tank is pressure rated the blowing agent may be added last and all the compositions mixed for a period of time until a homogenous mixture is produced.

### Surfactants

The surfactant can serve to regulate the cell structure of the foam by helping to control the cell size in the foam and reduce the surface tension during foaming via reaction of the aromatic polyesterpolyol and, optionally, other components, with an organic polyisocyanate. Surfactants such as silicone-polyoxyalkylene block copolymers, nonionic polyoxyalkylene glycols and their derivatives, and ionic organic salts of these surfactants can be used.

In particular, surfactants such as polydimethylsiloxane-polyoxyalkylene block copolymers under the trade names Dabco™ DC-193 and Dabco™ DC-5315 (Air Products and Chemicals, Allentown, Pa.), or Tegostab B8871 (EVON IC) ether sulfates, fatty alcohol sulfates, sarcosinates, amine oxides, sulfonates, amides, sulfo-succinates, sulfonic acids, alkanol amides, ethoxylated fatty alcohol, and nonionics such as polyalkoxylated sorbitan, and a combination thereof, can be used.

In an embodiment, the amount of surfactant in the composition can be from 0 wt % to 5 wt %, based on the total weight of the mixture. In an embodiment, the amount of surfactant in the composition can be from 0.1 wt % to 5 wt %, based on the total weight of the mixture. In an embodiment, the amount of surfactant in the composition can be from 1 wt % to 2 wt %, based on the total weight of the mixture.

### Blowing Agent

In an embodiment, the blowing agent can be made from any of the three classes of blowing agents and systems used to make polyurethane and polyisocyanurate foams which are well known in the art: the HCFC/HFC or HCFC/HFC/water co-blown system; a water/hydrocarbon co-blown system; and a water blown system (also referred to in the art as a carbon dioxide blown system since CO₂ is derived from the water-isocyanate reaction).

In the HCFC/HFC system, a liquid blowing agent is added to a mixture of aromatic polyesterpolyol, catalysts, and surfactants prior to adding a polyisocyanate. In the water blown system, water is added and mixed with an aromatic polyester polyol, catalyst, and surfactant mixture prior to adding a polyisocyanate. In the water and hydrocarbon co-blown system, both water and hydrocarbon blowing agents are added to an aromatic polyester polyol, catalyst surfactant premix prior to adding a polyisocyanate. The full-scale production of these components may be metered directly into the mixing head of the foam machine or premixed with an aromatic polyester polyol stream prior to injecting into the mixing head.

In an embodiment, a hydrogen atom-containing blowing agent can be employed to produce the foam compositions. These blowing agents, which can be used alone or as mixtures, can be selected from a broad range of materials, including partially halogenated hydrocarbons, ethers and esters, hydrocarbons, esters, ethers, and the like. Hydrogen-containing blowing agents include the HCFCs such as 1,1-dichloro-1-fluoroethane, 1,1-dichloro-2,2,2-trifluoro-ethane, monochlorodifluoromethane, and 1-chloro-1,1-difluoroethane; the HFCs such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; and the HFEs such as methyl-1,1,1-trifluoroethylether and difluoromethyl-1,1,1-trifluoro-ethylether. Hydrocarbon blowing agents include hydrocarbons such as n-pentane, isopentane, and cyclopentane.

Blowing agents containing predominately hydrocarbon compounds and only small amounts of fully halogenated hydrocarbons are desirable, for example ≤10 wt. %, ≤5 wt. % or ≤1 wt. %. For example, the blowing agents can be free of industrially detectable amounts of fully halogenated hydrocarbons.

In the case of foam applications, the PUR/PIR polymers, obtained using the resin blends of the present disclosure, may be foamed by use of a blowing agent. Blowing agent is a volatile material that liquefies and expands within the solidifying polymer composition, producing bubbles in the material, that are then present in the final foam structure containing the solid polymer reaction product. Foams can be adherent as well, depending on the nature of the object they contact, and can be used as insulation, packing, and the like. Or, the foam can be set up without adherence, producing solid foam blocks, sheets, packing peanuts, and the like.

The blowing agent can be a hydrocarbon having 3 to 7 carbon atoms, water, carbon dioxide, and a mixture thereof. The hydrocarbon can include butane, n-pentane, i-pentane, cyclopentane, hexane, cyclohexane, each of their alkene analogues, and a combination thereof. In some embodiments, the blowing agent is from 1 to 20% by weight, or preferably from 12 to 15% by weight, of the resin blend composition.

The blowing agent can include two or more blowing agents (e.g., blowing agent, co-blowing agent, and the like). For example, the blowing agent can be pentane and the co-blowing agent can be water, where pentane can be from 60 to 99% by weight of the blowing agents and water can be from 1 to 40% by weight of the blowing agents.

Hydrofluoroolefin (HFO) blowing agents can also be used. Examples of HFO blowing agents are disclosed in U.S. Pat. Nos. 8,772,364, 8,648,123, 8,314,159, 9,029,430 and US2014/0316020, all of which are incorporated by reference as if set forth at length herein.

Examples of HFO blowing agents may contain 3, 4, 5, or 6 carbons, and include but are not limited to pentafluoropropenes, such as 1,2,3,3,3-pentafluoropropene (HFO-1225ye); tetrafluoropropenes, such as 1,3,3,3-tetrafluoropropene (HFO-1234ze), E and Z isomers), 2,3,3,3-tetrafluoropropene (HFO-1234yf), and 1,2,3,3-tetrafluoropropene (HFO-1234ye); trifluoropropenes, such as 3,3,3-trifluoropropene (HFO-1234zf); tetrafluorobutenes, such as (HFO-1234); pentafluorobutene isomers, such as (HFO-1354); hexafluorobutene isomers, such as (HFO-1336); heptafluorobutene isomers, such as (HFO-1327); heptafluoropentene isomers, such as (HFO-1447); octafluoropentene isomers, such as (HFO-1438); nonafluoropentene isomers, such as (HFO-1429); and hydrochloroolefins, such as 1-chloro-3,3,3-trifluoropropene (HCFO-1233zd) (E and Z isomers), 2-chloro-3,3,3-trifluoropropene (HCFO-1233x0, HCFO-1223, 1,2-dichloro-1,2-difluoroethene (E and Z isomers), 3,3-dichloro-3-fluoropropene, 2-chloro-1,1,1,4,4,4-hexafluorobutene-2(E and Z isomers), and 2-chloro-1,1,1,3,4,4,4-heptafluorobutene-2(E and Z isomers). Preferred blowing agents in the thermosetting foam blends of the present invention include unsaturated halogenated hydroolefins with normal boiling points less than about 60° C. Preferred hydrochlorofluoroolefin and hydrofluoroolefin blowing agents include, but are not limited to, 1-chloro-3,3,3-trifluoropropene; E and/or Z HFO-1233zd; 1,3,3,3-tetrafluoropropene; E and/or Z HFO-1234ze; and HFO-1336, both cis and trans isomers.

The following Examples demonstrate the present invention and its capability for use. The invention is capable of other and different embodiments, and its several details are capable of modifications in various apparent respects, without departing from the spirit and scope of the present invention. Accordingly, the Examples are to be regarded as illustrative in nature and non-limiting.

### EXAMPLES

### Materials Used in the Examples

The term “Terate® HT-2000”, as used herein, refers to an aromatic polyester polyol that is manufactured by INVISTA and commercially available under the brand name INVISTA Terate® HT 2000 polyol.

The term “Terate® HT-2004”, as used herein, refers to an aromatic polyester polyol that is manufactured by INVISTA and commercially available under the brand name INVISTA Terate® HT 2004 polyol.

The term “Terate® HT-5500”, as used herein, refers to an aromatic polyester polyol that is manufactured by INVISTA and commercially available under the brand name INVISTA Terate® HT 5500 polyol.

The term “Terate® HT-5510”, as used herein, refers to an aromatic polyester polyol that is manufactured by INVISTA and commercially available under the brand name INVISTA Terate® HT 5510 polyol.

The term “TCPP”, as used herein, refers to tris(2-chloro-1-methylethyl) phosphate. The 95% (min.) concentration TCPP is available from Sigma-Aldrich, ICL Supresta, Albemarle, Shekoy, Cellchem and other commercial suppliers.

As used herein, Polycat® 46 and Dabco K-15 are a class of isocyanate trimerization catalysts that are known industrially. These are alkali metal carboxylate salts such as potassium acetate, potassium octoate.

As used herein, Polycat® 5 is a co-catalyst that is known to catalyze the reaction of water with isocyanate.

As used herein, the TEGOSTAB® B series silicone surfactants for closed-cell foams are commercially available from Evonik Industries.

The term “HLB”, as used herein, refers to a hydrophile-lipophile balance of a surfactant when present in the system. It is a measure of the degree to which it is hydrophilic or lipophilic.

The term “HLB additive”, as used herein, refers to an additive that may be used to balance the hydrophilic versus liphophilic properties in the formulation. The HLB characteristics are further defined in terms of an HLB Index or HLB Value, as commonly referred to in the industry. This HLB Index has a scale of 0 to 20. An HLB value of 0 corresponds to a completely lipophilic (or hydrophobic) molecule, and a value of 20 corresponds to a completely hydrophilic (or lipophobic) molecule. For example, the HLB Index of 5 to 20 can be suitable for the disclosed compositions. HLB values of 7 to 9 may indicate wetting and spreading agents, while greater than 10 HLB values may indicate water-soluble (lipid-insoluble) agents.

Non-limiting examples of HLB additives may include sorbitan, esters of sorbitan (commonly known as Spans), and mixtures thereof. Esters of sorbitan may include sorbitan monostearate, sorbitan tristearate, sorbitan monolaurate, ethoxylated sorbitan esters or polysorbate, and such. These commercially available HLB additives are well-known in the food, pharmaceutical, cosmetics and chemical industries. Also, the skilled person in the field of surfactants and/or foam industry understands what is meant by HLB additive, HLB Index or HLB value.

### Test Methods Used in the Examples

The acid number (AN) or acid value (AV) determination is performed according to ASTM D-4662. The acid number unit of measurement is mg KOH/g of sample.

The hydroxyl number (HN) or hydroxyl value (HV) determination is performed according to ASTM D-4274. The hydroxyl number unit of measurement is mg KOH/g of sample.

The water content in the sample is determined according to ASTM D-4672. The water content is measured as wt. % relative to the total sample weight.

The sample viscosity at 25° C. is determined according to ASTM D-4878. The viscosity is measured in the units of centipoise (cps).

In the embodiments of this disclosure, foam preparation is by handmix method.

Friability Test—As described in U.S. Pat. Nos. 3,933,698 and 4,071,482; the disclosures of each herein incorporated by reference in their entirety, a surface friability test is conducted using the finger test method. Foam is produced in a single cup by machine mixing both “A-side” and “B-side” components together. As the chemicals react the foam produced rises above the rim of the cup. The top portion of the foam is called the crown. At different time intervals, a fingernail is rubbed across the crown with slight downward pressure. The surface friability is observed as being High, Moderate or Low. A High rating indicates considerable surface crumbling, a Moderate rating indicates slight surface crumbling and a Low rating indicates no surface crumbling.

Foam properties are measured according to various standard test methods. K-factor is measured according to ASTM C518-04 for Steady State Thermal Transmission Properties by Means of the Heat Flow Meter Apparatus. Aged K-Factor are based on foams stored at 70° C. for the specified time. Closed cell content is determined as 100% minus open cell content, which is measured according to ASTM D6226-05 for Open Cell Content of Rigid Cellular Plastics. Humid age dimensional stability is measured according to ASTM D2126-04 for Response of Rigid Cellular Plastics to Thermal and Humid Aging. Foam density is measured according to ASTM D1622-93 for Apparent Density of Rigid Cellular Plastics. Compressive strength is measured according to ASTM D1621-94 for Compressive Properties of Rigid Cellular Plastics. ASTM standard methods are from ASTM International, West Conshohocken, Pa., USA, www.astm.org.

The following terms are used in accordance with ASTM D7487-13 “Standard Practice for Polyurethane Raw Materials: Polyurethane Foam Cup Test.

“Cream Time” or “CT” is the time when bubbles start to make the level of liquid to rise.

“Gel Time” or “GT” is the time when strings can no longer be pulled during the foaming reaction.

“Tack Free Time” or “TFT” is the time when the foam is no longer tacky or sticky.

The term “End of Rise” or “E.R.”, as used herein, is the time when the foam stops rising during the foaming process.

The term “Isocyanate Index”, as used herein, is the ratio of amount of isocyanate used to theoretical amount of isocyanate needed to react all available OH groups in a formulation.

The term “K-Factor”, as used herein, is a measure of heat in British-thermal-units (BTUs) that passes through a 1-inch thick, 1-ft² of foam surface area in 1 hour, for each degree Fahrenheit (or ° F.) temperature interval.

The term “R-Value”, as used herein, is the inverse of the K-factor and is a measure of thermal resistance for a particular material such as rigid foam.

Foams, according to the present disclosure, are generated via hand-mix preparations. Various foams are also generated from pilot laminators. Foam performance is monitored using procedures set forth in standard methods, namely, ASTM D-1622 for density measurements, ASTM C-518 for initial and aged K-factor data, ASTM D-2126 for dimensional stability, and ASTM D-1621 for compressive strength.

The polyols are characterized for acidity, hydroxyl values, and viscosities at 25° C. The total acid number (AN) and hydroxyl values (OH) are determined by using the standard titration methods. Dynamic viscosity measurements are done at 25° C. on a Brookfield viscometer.

### Examples 1(a-g)—Foam Preparations with Iso-Pentane Blowing Agent

In these illustrative examples, a commercially available aromatic polyester polyol, namely, INVISTA Terate® HT-2000 polyol, is used along with the components and quantities as described in Table I.

An industrial method of “A-side” and “B-side” components reaction is employed to prepare several cellular foam specimens using the Table I polyol resin blendas the B-side component.

In the examples of Table I, the blowing agent can be a hydrocarbon having 3 to 7 carbon atoms, such as butane, n-pentane, iso-pentane, cyclopentane, hexane, cyclohexane, each of their alkene analogues, and a combination thereof. Iso-pentane is used as a blowing agent in these examples. Surfactant can be silicone based surfactants, such as, commercially available L5162 surfactant, TEGOSTAB® B series silicone surfactants for closed-cell foams commercially available from Evonik Industries, or similar. Catalysts may include isocyanate trimerization catalysts of types Polycat®, Dabco®, along with commercial amine catalysts used in the foam industry.

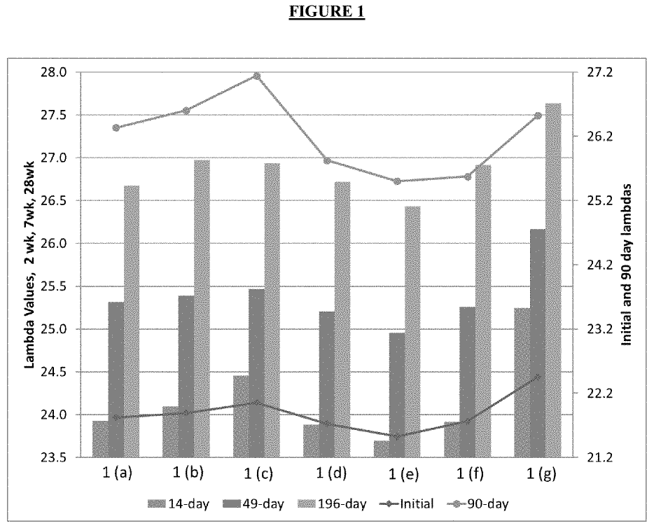

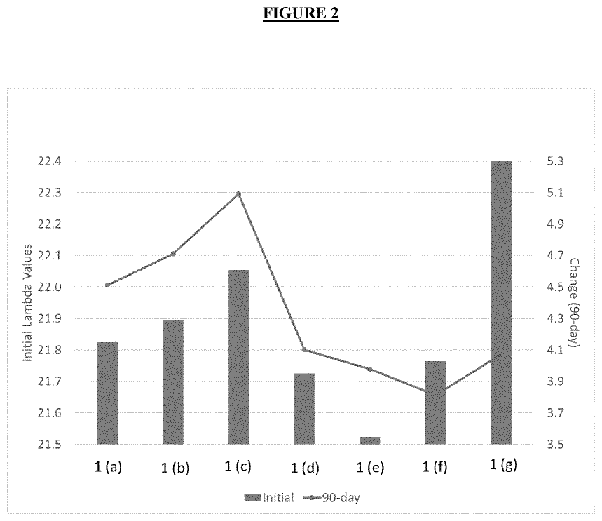

For the foam specimens prepared according to the Table I components, FIGS. 1 and 2 show unexpected Lambda value trend. In FIG. 1, the X-axis corresponds to those foam specimens of Examples 1(a-g). The left-side Y-axis shows the foam specimen Lambda values (bars with color legend) observed at 2-week (14 days), 7-week (49 days) and 28-week (196 days) time periods. The right-side Y-axis shows the foam Lambda values observed at initial (blue data line) and 90-day (orange line) time periods.

TABLE I

| Specimen ID | 1(a) | 1(b) | 1(c) | 1(d) | 1(e) | 1(f) | 1(g) |
|---|---|---|---|---|---|---|---|
| HLB Index | (Control) | #8 | #10 | #12 | #14 | #20 | #8_#20 |
| weight units | | | | | | | |
| Polyol | 87-92 | | | | | | |
| HLB Additive | 0-5 | | | | | | |
| TCPP | 13.0 | | | | | | |
| Surfactant | 2.2 | | | | | | |
| Catalysts | 4.0 | | | | | | |
| water | 0.9 | | | | | | |
| Blowing Agent | 19.5 | | | | | | |
| Isocyanate Index | 2.8 | | | | | | |
| Reactivity Profile | | | | | | | |
| Cream Time, sec | 8 | 8 | 8 | 8 | 7 | 7 | 7 |
| Gel Time, sec | 31 | 33 | 32 | 32 | 31 | 31 | 33 |
| Tack Free Time, sec | 46 | 57 | 45 | 52 | 45 | 43 | 46 |
| E.R | 55 | 60 | 59 | 56 | 55 | 51 | 58 |
| Density, lb/ft³ | 1.85 | 1.86 | 1.88 | 1.88 | 1.89 | 1.85 | 1.77 |
| Lambda Value | | | | | | | |
| Initial | 21.8 | 21.9 | 22.1 | 21.7 | 21.5 | 21.8 | 22.5 |
| 7-day | 23.8 | 24.2 | 24.7 | 23.8 | 24.0 | 24.0 | 25.4 |
| 14-day | 23.9 | 24.1 | 24.5 | 23.9 | 23.7 | 23.9 | 25.2 |
| 28-day | 25.5 | 25.8 | 26.0 | 25.7 | 25.3 | 25.8 | 26.7 |
| 49-day | 25.3 | 25.4 | 25.5 | 25.2 | 25.0 | 25.3 | 26.2 |
| 90-day | 26.3 | 26.6 | 27.1 | 25.8 | 25.5 | 25.6 | 26.5 |
| 196-day | 26.7 | 27.0 | 26.9 | 26.7 | 26.4 | 26.9 | 27.6 |
| Volume % Change | | | | | | | |
| Freezer 14-day | 2% | 3% | 2% | 2% | 2% | 1% | 2% |
| Humid Age 14-day | 11% | 11% | 9% | 9% | 9% | 9% | 7% |

In FIG. 2, the initially observed lambda values (blue bars) are represented on the left-side Y-axis, while the 90-day change from the initially observed lambda values (red data line) is represented on the right-side Y-axis. As an example, a 90-day lambda value change of about 4.0 means the 90-day lambda value is about four points higher than the initially observed lambda value. Both FIGS. 1 and 2 show that the lambda value trends are consistent throughout the tested time period. The lower Lambda value means improved thermal insulation properties of foam specimens.

Example 1(a) is a control experiment wherein HLB additive is not present. In Example 1(b-g), the HLB additive is included in up to 5 weight units to yield the respective HLB Index # as shown in Table 1. In Example 1(g), a combination of HLB additives is tested to yield the HLB #8_#20 combination.

### Examples 2(a-c)—Foam Preparations with Hydrofluoro-Olefin [HFO] Blowing Agent

In these illustrative examples, a commercially available aromatic polyester polyol, namely, INVISTA Terate® HT-5510 polyol, is used along with the components and quantities as described in Table II.

An industrial method of “A-side” and “B-side” components reaction is employed to prepare several cellular foam specimens using the Table II polyol resin blend as the B-side component.

In the examples of Table II, the blowing agent used is a hydrofluoro-olefin (HFO) class, for example, Solstice® Liquid Blowing Agent (LBA), a commercial product of Honeywell, or similar.

Surfactant can be silicone based surfactants, such as, commercially available L5162 surfactant. Catalysts may include isocyanate trimerization catalysts of types Polycat®, Dabco®, along with commercial amine catalysts used in the foam industry. The fire retardant component may be TCPP or similar.

In the examples of Table II, an aryl diol, resorcinol, is used as an R-value enhancing additive. Example 2(a) is a control experiment wherein the R-value enhancing additive is not present.

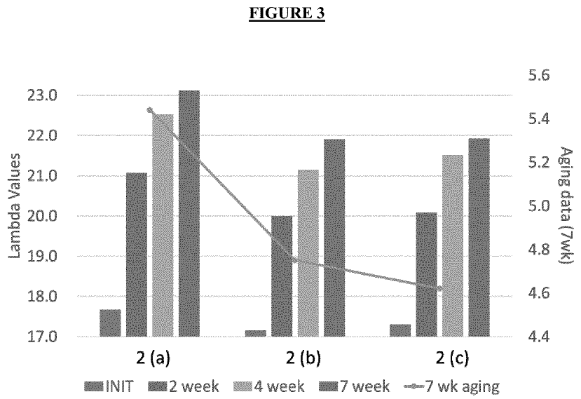

For the foam specimens prepared according to the Table II components, FIG. 3 shows unexpected Lambda value trends (bars with color legend) observed for initial, 2-week, 4-week and 7-week time periods on the left-side Y-axis, along with the 7-week stabilized aging trend (blue data line) on the right-side Y-axis. The lambda value trends are consistent over the time periods observed for the Table II foam specimens. The lower Lambda value means improved thermal insulation properties of foam specimens. Example 2(a) is a control experiment wherein the R-value enhancing additive, resorcinol, is not present.

TABLE II

| | Specimen ID | | |
|---|---|---|---|
| | 2(a) | 2(b) | 2(c) |
| | 0% resorcinol | 1.7% resorcinol | 3.5% resorcinol |
| weight units | | | |
| Polyol | 100 | 98.3 | 96.5 |
| Additive [R-value | — | 1.7 | 3.5 |
| enhancing additive] | 7.5 | 7.5 | 7.5 |
| Flame Retardant | 2.0 | 2.0 | 2.0 |
| Surfactant | 1.65 | 1.65 | 1.65 |
| Dabco ® K-15 | 0.35 | 0.35 | 0.35 |
| Polycat ® 5 | 0.50 | 0.50 | 0.50 |
| water | 32.0 | 32.0 | 32.0 |
| Blowing Agent | | | |
| Isocyanate Index | 3.0 | | |
| Density, | 2.44 | 2.41 | 2.69 |
| lb/ft³ | | | |
| Reactivity Profile | | | |
| Cream Time, sec | 12 | 13 | 13 |
| Gel Time, sec | 45 | 41 | 35 |
| Tack Free Time, sec | 70 | 58 | 55 |
| E.R | 77 | 76 | 77 |
| K-Factor | | | |
| Initial | 0.123 | 0.119 | 0.120 |
| 2-week | 0.146 | 0.139 | 0.139 |
| 4-week | 0.156 | 0.147 | 0.149 |
| 7-week | 0.160 | 0.152 | 0.152 |
| Lambda Value | | | |
| Initial | 17.7 | 17.2 | 17.3 |
| 2-week | 21.1 | 20.0 | 20.1 |
| 4-week | 22.5 | 21.1 | 21.5 |
| 7-week | 23.1 | 21.9 | 21.9 |
| 7-week aging (change) | 5.4 | 4.8 | 4.6 |
| Volume % Change | | | |
| Freezer, | | | |
| 7-day | 0% | −0.7% | −1.0% |
| 14-day | 0% | 0% | −1.0% |
| Volume % Change | | | |
| Humid Age, | | | |
| 7-day | 2% | 3% | 3% |
| 14-day | 3% | 5% | 4% |
| Compressive Strength | | | |
| Parallel, Psi | 59.5 | 63.1 | 52.0 |
| Perpendicular, Psi | 23.2 | 21.9 | 24.0 |

### Examples 3(a-d)—Foam Preparations with Hydrofluoro-olefin Blowing Agent

In these illustrative examples, a commercially available aromatic polyester polyol, namely, INVISTA Terate® HT-5510 polyol, is used along with the components and quantities as described in Table III.

An industrial method of “A-side” and “B-side” components reaction is employed to prepare several cellular foam specimens using the Table III polyol resin blendas the B-side component.

In the examples of Table III, the blowing agent used is a hydrofluoro-olefin (HFO), for example, Solstice® Liquid Blowing Agent (LBA), a commercial product by Honeywell, or similar.

Surfactant can be silicone based surfactants, such as, commercially available L5162 surfactant, TEGOSTAB® B series silicone surfactants for closed-cell foams commercially available from Evonik Industries, or similar. Catalysts may include isocyanate trimerization catalysts of types Polycat®, Dabco®, along with commercial amine catalysts used in the foam industry. The fire retardant component may be TCPP or similar.

In the examples of Table III, an aryl diol, resorcinol, is used as an R-value enhancing additive. In Example 3(a), the R-value enhancing additive is not present.

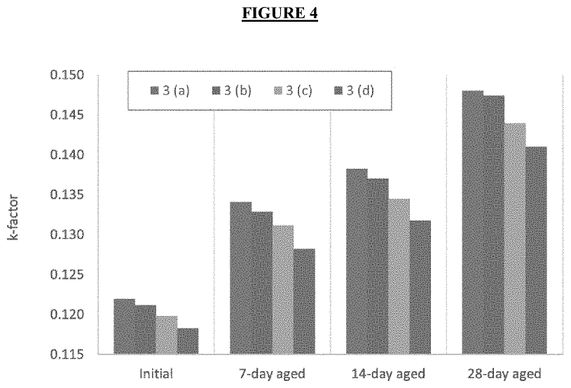

For the foam specimens prepared according to the Table III components, FIG. 4 shows unexpected K-Factor trends (represented on the Y-axis with color legend) observed over 1-day, 7-day, 14-day and 28-day time periods as represented on the X-axis. Example 3(a) is a control experiment wherein the R-value enhancing additive, resorcinol, is not present.

TABLE III

| Specimen ID | 3(a) | 3(b) | 3(c) | 3(d) |
|---|---|---|---|---|
| weight units | | | | |
| Polyol | 99-100 | 99-100 | 99-100 | 99-100 |
| Additive [R-value | — | 0.1 | 0.25 | 0.8 |
| enhancing additive] | 8.0 | 8.0 | 8.0 | 8.0 |
| Flame Retardant | 2.0 | 2.0 | 2.0 | 2.0 |
| Surfactant | 2.0 | 2.0 | 2.0 | 2.0 |
| Catalysts | 0.3 | 0.3 | 0.3 | 0.3 |
| water | 37.0 | 37.0 | 37.0 | 37.0 |
| Blowing Agent | | | | |
| Isocyanate Index | 3.0 | | | |
| Density, lb/ft ³ | 2.23 | 2.20 | 2.23 | 2.40 |
| Reactivity Profile | | | | |
| Cream Time, sec | 12 | 11 | 14 | 11 |
| Gel Time, sec | 50 | 52 | 50 | 54 |
| Tack Free Time, sec | 66 | 67 | 65 | 66 |
| E.R | 76 | 78 | 77 | 76 |
| % Rise at Gel | 81.6% | 82.1% | 81.6% | 84.3% |
| K-Factor | | | | |
| 1-day | 0.122 | 0.121 | 0.120 | 0.118 |
| 7-day | 0.134 | 0.133 | 0.131 | 0.128 |
| 14-day | 0.138 | 0.137 | 0.134 | 0.132 |
| 28-day | 0.148 | 0.147 | 0.144 | 0.141 |
| Lambda Value | | | | |
| 1-day | 17.6 | 17.5 | 17.3 | 17.1 |
| 7-day | 19.3 | 19.2 | 18.9 | 18.5 |
| 14-day | 19.9 | 19.8 | 19.4 | 19.0 |
| 28-day | 21.3 | 21.3 | 20.8 | 20.3 |
| Volume % Change | | | | |
| Freezer, | | | | |
| 7-day | 2% | 2% | 0% | 2% |
| 14-day | 0% | 0% | 0% | 0% |
| Volume % Change | | | | |
| Humid Age, | | | | |
| 7-day | 9% | 7% | 9% | 11% |
| 14-day | 9% | 6% | 9% | 11% |
| Compressive Strength | | | | |
| Parallel, Psi | 43.8 | 38.7 | 37.0 | 32.5 |
| Perpendicular, Psi | 17.1 | 15.3 | 17.6 | 15.0 |

### Examples 4(a-d)—Foam Preparations Using Cyclo-/Iso-Pentane Blowing Agent

In these illustrative examples, a commercially available aromatic polyester polyol, namely, INVISTA Terate® HT-5510 polyol is used in foam preparations. An aryl diol, resorcinol, is used as an R-value enhancing additive. In repeat Examples 4(a) and 4(d), resorcinol is not present.

An industrial method of “A-side” and “B-side” components reaction is employed to prepare several cellular foam specimens and the insulation properties are determined by measuring their initial and 4-week aged K-Factors, Lambda values and R-values.

In the examples of Table IV, the blowing agent can be a hydrocarbon having 3 to 7 carbon atoms, such as butane, n-pentane, iso-pentane, cyclopentane, hexane, cyclohexane, each of their alkene analogues, and a combination thereof. An 85:15 weight ratio of cyclo-/Iso-pentane is used as a blowing agent in all these examples. Surfactant can be silicone based surfactants, such as, commercially available NIAX® L5162 surfactant from Momentive Performance Materials Inc. Catalysts may include isocyanate trimerization catalysts of types Polycat®, Dabco®, along with commercial amine catalysts used in the foam industry.

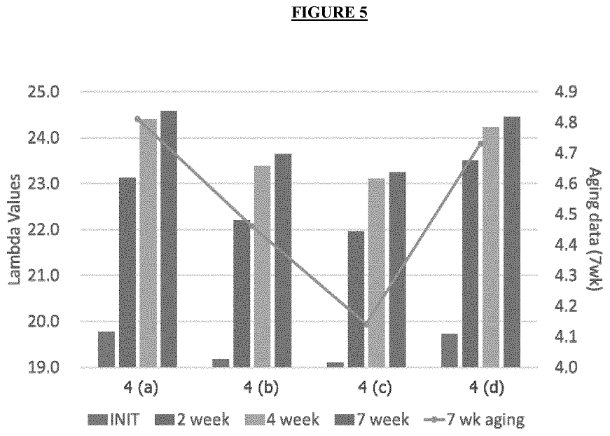

For the foam specimens prepared according to the Table IV components, FIG. 5 shows unexpected Lambda value trend. In FIG. 5, the X-axis represents those foam specimens of Examples 4(a-d). The left-side Y-axis shows the foam specimen Lambda values (bars with color legend) observed at initial, 2-week, 4-week and 7-week time periods. Also in FIG. 5, Lambda value change (blue data line) over the 7-week period from the initially observed lambda values is represented on the right-side Y-axis. The lower Lambda value means improved thermal insulation properties of foam specimens. The lambda values determined at initial, 2-week, 4-week and 7-week time periods, and the Lambda values change during 7-week aging, all show surprising and unexpected drop in the presence of resorcinol at levels described in Table IV.

TABLE IV

| Specimen ID | 4(a) | 4(b) | 4(c) | 4(d) |
|---|---|---|---|---|
| Polyol used | TERATE ® HT-5510 | | | |
| Blowing Agent | 85:15 Cyclo-/Iso-pentane | | | |
| By weight | | | | |
| Polyol | | 98.5-100 | | |
| Flame Retardant | | 7.50 | | |
| Silicon Surfactant | | 2.0 | | |
| Catalysts | | 2.0 | | |
| Water | | 0.5 | | |
| Blowing Agent | | 22.0 | | |
| Additive [R-value | 0% Resorcinol | 0.8% Resorcinol | 1.5% Resorcinol | 0% Resorcinol |
| enhancing additive] | | | | |
| Foam Density, | 1.88 | 1.88 | 1.90 | 1.95 |
| lb/ft³ | | | | |
| Isocyanate Index | 3.0 | 3.0 | 3.0 | 3.0 |
| K-Factor | | | | |
| Initial | 0.137 | 0.133 | 0.132 | 0.137 |
| 4-week | 0.169 | 0.162 | 0.160 | 0.168 |
| Lambda Value | | | | |
| Initial | 19.8 | 19.2 | 19.1 | 19.7 |
| 2-week | 23.1 | 22.2 | 22.0 | 23.5 |
| 4-week | 24.4 | 23.4 | 23.1 | 24.2 |
| 7-week | 24.6 | 23.6 | 23.2 | 24.5 |
| 7-week aging | 4.8 | 4.5 | 4.1 | 4.7 |
| (change) | | | | |
| R-Value | | | | |
| Initial | 7.30 | 7.52 | 7.55 | 7.31 |
| 4-week | 5.91 | 6.17 | 6.24 | 5.95 |

### Example 5(a-f)—Foam Preparations Using Different Surfactants

In these illustrative examples, a commercially available aromatic polyester polyol, namely, INVISTA Terate® HT-2000 polyol is used in foam preparations. An aryl diol, resorcinol, is used as an additive except in control experiments 5(a), 5(c) and 5(e).

An industrial method of “A-side” and “B-side” components reaction is employed to prepare several cellular foam specimens and the insulation properties are determined by measuring their K-Factor and Lambda values.

In the examples of Table V, surfactant can be silicone based surfactants, such as, commercially available L5111, L5162 surfactants, TEGOSTAB® B series silicone surfactants for closed-cell foams commercially available from Evonik Industries, or similar. The catalyst level used in these examples is about 1.29% (by weight) and may include isocyanate trimerization catalysts of types Polycat®, Dabco®, along with commercial amine catalysts used in the foam industry. The fire retardant component may be TCPP or similar.

TABLE V

| Specimen ID | 5(a) | 5(b) | 5(c) | 5(d) | 5(e) | 5(f) |
|---|---|---|---|---|---|---|
| Polyol Used | Terate ® HT-2000 | | | | | |
| Resorcinol | 0.0 | 0.8% | 0.0 | 0.8% | 0.0 | 0.8% |
| Surfactant | SURF 1 | | SURF 2 | | SURF 3 | |
| weight units | | | | | | |
| Polyol | 99-100 | | | | | |
| Fire Retardant | 12 | | | | | |
| Surfactant | 2-3 | | | | | |
| Catalysts | 4-5 | | | | | |
| water | 0.8 | | | | | |
| Blowing Agent | 21-22 | | | | | |
| Isocyanate Index | 3.0 | 3.0 | 3.0 | 3.0 | 3.0 | 3.0 |
| Density, | 1.90 | 1.90 | 1.84 | 1.80 | 1.84 | 1.82 |
| lb/ft³ | | | | | | |
| Reactivity Profile | | | | | | |
| Cream Time, sec | 9 | 9 | 11 | 8 | 12 | 9 |
| Gel Time, sec | 27 | 25 | 30 | 28 | 35 | 28 |
| Tack Free Time, sec | 43 | 36 | 44 | 45 | 48 | 41 |
| K-Factor | | | | | | |
| Initial | 0.135 | 0.129 | 0.137 | 0.134 | 0.138 | 0.133 |
| 1-week | 0.147 | 0.138 | 0.149 | 0.143 | 0.151 | 0.143 |
| 2-week | 0.155 | 0.145 | 0.157 | 0.150 | 0.158 | 0.150 |
| 4-week | 0.160 | 0.150 | 0.162 | 0.155 | 0.163 | 0.155 |
| 15-week | 0.166 | 0.156 | 0.167 | 0.160 | 0.169 | 0.160 |
| Lambda Value | | | | | | |
| Initial | 19.4 | 18.7 | 19.8 | 19.3 | 19.9 | 19.2 |
| 1-week | 21.2 | 19.9 | 21.5 | 20.6 | 21.8 | 20.6 |
| 2-week | 22.4 | 20.9 | 22.7 | 21.7 | 22.8 | 21.8 |
| 4-week | 23.1 | 21.6 | 23.4 | 22.3 | 23.5 | 22.4 |
| 15-week | 24.0 | 22.4 | 24.1 | 23.0 | 24.3 | 23.1 |

The effect of the presence of resorcinol on foam properties can be seen by comparing Example 5(a) with 5(b), Example 5(c) with 5(d), and Example 5(e) with 5(f).

### Example 6—Foam Preparations with HLB and R-Value Enhancing Additives Combinations

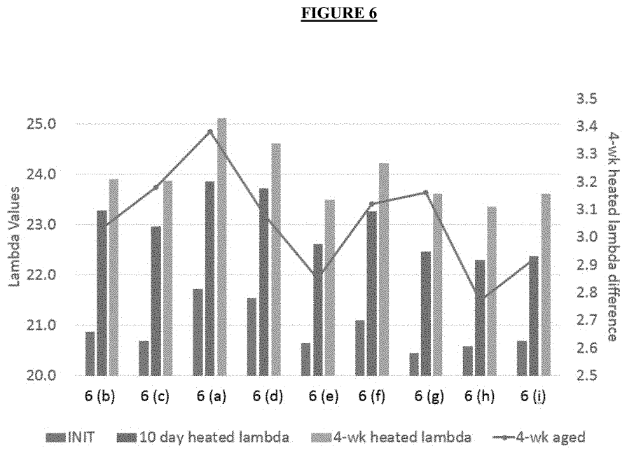

In these illustrative examples, a commercially available aromatic polyester polyol, namely, INVISTA Terate® HT-2004 polyol is used in foam preparations. An aryl diol, resorcinol, is used as an R-value enhancing additive. A commercially available HLB additive is used to target the HLB Index number as represented in Table VI and FIG. 6.

An industrial method of “A-side” and “B-side” components reaction is employed to prepare several cellular foam specimens and the insulation properties are determined by measuring their initial Lambda values, 10-day and 4-week heated Lambda values, and xx-week Lambda value change (aging data).

In the examples of Table VI, the blowing agent can be a hydrocarbon having 3 to 7 carbon atoms, such as butane, n-pentane, iso-pentane, cyclopentane, hexane, cyclohexane, each of their alkene analogues, and a combination thereof. Pureiso-pentane: water is used as the hydrocarbon blowing agent in all these examples. Surfactant can be silicone based surfactants. Surfactants used may be silicone based surfactants, such as, commercially available L5111, L5162 surfactants, TEGOSTAB® B series silicone surfactants for closed-cell foams commercially available from Evonik Industries, or similar. The commercial TEGOSTAB® B8871 surfactant is used in the examples of Table VI. Catalysts may include isocyanate trimerization catalysts of types Polycat®, Dabco®, along with commercial amine catalysts used in the foam industry. The fire retardant component may be TCPP or similar.

TABLE VI

| Specimen ID | 6(a) | 6(b) | 6(c) | 6(d) | 6(e) | 6(f) | 6(g) | 6(h) | 6(i) |
|---|---|---|---|---|---|---|---|---|---|
| weight units | | | | | | | | | |
| Polyol | 86-94 | | | | | | | | |
| Flame Retardant | 10-14 | | | | | | | | |
| Surfactant | 2.2 | | | | | | | | |
| Catalysts | 4.0 | | | | | | | | |
| water | 0.9 | | | | | | | | |
| Blowing Agent | 19.5 | | | | | | | | |
| Additive [HLB] | 0 | 0 | 0 | ≤5 | ≤5 | ≤5 | ≤5 | ≤5 | ≤5 |
| HLB Index # | 0 | 0 | 0 | 12 | 14 | 16 | 12 | 14 | 16 |
| Additive [R-value | 0 | ≤1 | ≤1 | 0 | 0 | 0 | ≤1 | ≤1 | ≤1 |
| enhancing additive] | | | | | | | | | |
| Isocyanate Index | 2.8 | | | | | | | | |
| Lambda Value | | | | | | | | | |
| Initial | 21.7 | 20.9 | 20.7 | 21.5 | 20.6 | 21.1 | 20.4 | 20.6 | 20.7 |
| 10-day (heated) | 23.8 | 23.3 | 23.0 | 23.7 | 22.6 | 23.3 | 22.5 | 22.3 | 22.4 |
| 4-week (heated) | 25.1 | 23.9 | 23.9 | 24.6 | 23.5 | 24.2 | 23.6 | 23.4 | 23.6 |
| 4-week aged (change) | 3.4 | 3.0 | 3.2 | 3.1 | 2.9 | 3.1 | 3.2 | 2.8 | 2.9 |

In the control Example 6(a), both the HLB additive and R-value enhancing additive are not present during foam preparation. In Examples 6(b-c), the HLB additive is not present and only the R-value enhancing additive is present in up to ≤1.0 (weight basis). In Example 6(d-f), the R-value enhancing additive is not present and only the HLB additive is present in up to (weight basis). Example 6(g), 6(h) and 6(i) are performed with both, the HLB additive as well as R-value enhancing additive in up to ≤5.0 and ≤1.0 (weight basis), respectively. For examples that include the HLB additive, the amount of HLB additive is varied to yield the HLB Index values of 12, 14 and 16, as shown in Table VI.

For the foam specimens prepared according to the Table VI components, FIG. 6 shows unexpected Lambda value trends. In FIG. 6, the X-axis represents those foam specimens corresponding to Examples 6(a-i). The left-side Y-axis shows the foam specimen Lambda values (bars with color legend) observed at initial, 10-day and 4-week heated test conditions. Also in FIG. 6, Lambda value change (purple data line) over the 4-weekaged period from the initially observed lambda values is represented on the right-side Y-axis. The lower Lambda value means improved thermal insulation properties of foam specimens.

The unexpected and surprising effect from the presence of both, HLB additive and R-value enhancing additive (resorcinol in these examples), on the lambda values at all tested time periods can be compared with the control Example 6(a).

While the illustrative embodiments of the invention have been described with particularity, it will be understood that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

What is claimed is:

1. A foam precursor comprising:
a. polyol;
b. R-value enhancing additive comprising a compound selected from aryl diols, substituted aryl diols, aryl triols, substituted aryl triols and combinations thereof; and
c. surfactant, wherein the HLB number of the surfactant is from 5 to 20 on Griffin's scale.

2. The foam precursor of claim 1 wherein the polyol comprises a polyester polyol.

3. The foam precursor of claim 2 wherein the polyester polyol comprises an aromatic polyester polyol.

4. The foam precursor of claim 1 wherein the R-value enhancing additive comprises resorcinol.

5. The foam precursor of claim 1 wherein the R-value enhancing additive comprises from 80 to 100 wt % resorcinol.

6. The foam precursor of claim 1 wherein the HLB number of the surfactant is from 10 to 20 on Griffin's scale.

7. The foam precursor of claim 1 wherein it is a homogeneous mixture with viscosity in the range of 500 to 10,000 centipoise, determined at 25° C. according to ASTM D-4878.

8. An emulsion comprising a reaction product of the foam precursor of claim 7.

9. A foam composition comprising a reaction product of the foam precursor of claim 1 with organic isocyanate, the reaction product having a weight per unit volume of at least 1.4 lb/ft³ and insulation R-value of greater than 6.

10. The foam composition of claim 9 wherein the reaction product has a weight per unit volume of from 1.4 to 1.6 lb/ft³.

11. The foam composition of claim 9 wherein the reaction product has a weight per unit volume of 1.5 lb/ft³.

12. The foam composition of claim 9 comprising a blowing agent.

13. The foam composition of claim 12 wherein the blowing agent contains less than 1 wt % fully halogenated alkanes.

14. A foam composition comprising:
a. aromatic polyester polyol;
b. R-value enhancing additive comprising a compound selected from aryl diols, substituted aryl diols, aryl triols, substituted aryl triols and combinations thereof;
c. surfactant, wherein the HLB number of the surfactant is from 5 to 20 on Griffin's scale;
d. an isocyanate; and
e. blowing agent.

15. The foam composition of claim 14 wherein the R-value enhancing additive comprises resorcinol.

16. The foam composition of claim 15 wherein the R-value enhancing additive comprises from 80 to 100 wt % resorcinol.

17. The foam composition of claim 14 wherein the HLB number of the surfactant is from 10 to 20 on Griffin's scale.

18. The foam composition of claim 14 wherein the blowing agent contains less than 1 wt % fully halogenated alkanes.

19. The foam composition of claim 14 wherein the blowing agent contains from 0.1 to less than 1 wt % fully halogenated alkanes.

20. The foam composition of claim 14 produced from an emulsion composition comprising a homogeneous mixture which comprises polyol, R-value enhancing additive and surfactant, with viscosity in the range of 500 to 10,000 centipoise, determined at 25° C. according to ASTM D-4878, wherein the emulsion composition is reacted with organic isocyanate at conditions sufficient to develop a cellular matrix substance having the weight per unit volume of at least 1.4 lb/ft′ and insulation R-value of greater than 6.

21. The foam composition of claim 20 having more nearly spherical and more uniformly sized and distributed cell structure than the same composition formed in the absence of the R-value enhancing additive comprising a compound selected from aryl diols, substituted aryl diols, aryl triols, substituted aryl triols and combinations thereof.

22. The foam composition of claim 20 having more nearly spherical and more uniformly sized and distributed cell structure than the same composition formed in the absence of the R-value enhancing additive comprising resorcinol.

23. A closed-cell foam reaction product of polyester polyol, isocyanate, R-value enhancing additive and surfactant formed in the presence of blowing agent, wherein:
a. the R-value enhancing additive comprises a compound selected from aryl diols, substituted aryl diols, aryl triols, substituted aryl triols and combinations thereof; and
b. the concentration of the surfactant on the surfaces of the closed cells is greater than the concentration of the surfactant in the bulk of the cell walls.

24. The closed-cell foam of claim 23 wherein the HLB number of the surfactant is from 5 to 20 on Griffin's scale.

25. The closed-cell foam of claim 23 wherein the HLB number of the surfactant is from 10 to 20 on Griffin's scale.

26. The closed-cell foam of claim 23 wherein the R-value enhancing additive comprises from 80 to 100 wt % resorcinol.
